(19) United States
(12) Patent Application Publication
(10) Pub. No.: US 2008/0240952 A1
(43) Pub. Date: Oct. 2, 2008

(54) High-Pressure Pump, in Particular for a Fuel Injection System of an Internal Combustion Engine

(76) Inventors: Nestor Rodriguez-Amaya, Stuttgart (DE); Michael Mennicken, Wimsheim (DE); Peter Brendle, Engstingen (DE); Falko Bredow, Remseck (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/586,872

(22) PCT Filed: Jan. 13, 2005
(86) PCT No.: PCT/EP2005/050126

§ 371 Date: Jul. 21, 2006

(30) Foreign Application Priority Data
Feb. 11, 2004 (DE) 10 2004 006 700.7
Jun. 8, 2004 (DE) 10 2004 027 825.3

(51) Int. Cl. F02M 37/06; F04B 19/22

(52) U.S. Cl. 417/499; 123/495

(57) ABSTRACT

A high-pressure pump having a pump element a pump piston driven in a reciprocating motion and defining a pump work chamber into which fuel is aspirated from a fuel inlet during the intake stroke via an inlet valve, and from which fuel is positively displaced via an outlet valve during the pumping stroke. The inlet valve has a valve member which with a sealing face inclined relative to its longitudinal axis, cooperates with a valve seat disposed in a valve housing when the sealing face of valve member is lifted from the valve seat, a flow cross section between the valve member and the valve housing is opened between the fuel inlet and the pump work chamber. In the opened state, a region having the smallest flow cross section between the valve member and the valve housing is disposed downstream, of the sealing face of the valve member.

### PRIOR ART

The invention is based on a high-pressure pump, in particular for a fuel injection system of an internal combustion engine, as generically defined by the preamble to claim 1.

One such high-pressure pump is known from German Patent Disclosure DE 198 60 672 A1. This high-pressure pump has at least one pump element, with a pump piston, which is driven in a reciprocating motion and which defines a pump work chamber. In the intake stroke of the pump piston, via an inlet valve, fuel is aspirated from a fuel inlet, and in the pumping stroke of the pump piston, via an outlet valve, fuel is positively displaced out of the pump work chamber. The inlet valve has a valve member with a sealing face that is inclined relative to its longitudinal axis and with which it cooperates with a valve seat disposed in a valve housing. The outlet valve has a spherical valve member, which cooperates with a valve seat disposed in a valve housing. By means of the applicable valve member, in the opened state when this valve member has lifted with its sealing face from the valve seat, a flow cross section is opened between the valve member and the valve housing. In the opened state of the valve, the smallest flow cross section between the valve member and the valve housing is located in the region of the sealing face of the valve member, and as a result there is a high flow velocity there and a correspondingly lower static pressure in the region of the sealing face and consequently only a slight force acting in the opening direction of the valve member. Depending on the stroke of the valve member and on the pressure difference, forces in the closing direction may even act on the valve member. For keeping the inlet valve open, a major pressure difference between the fuel inlet and the pump work chamber is therefore necessary, which in turn necessitates a high pressure in the fuel inlet and hence a correspondingly large-sized feed pump to generate this pressure. In the flow through the inlet valve, there is moreover a great pressure loss, making filling of the pump work chamber more difficult. This pressure loss corresponds to the required pressure difference for filling the pump work chamber. Because of the resultant hydraulic forces, the outlet valve has a tendency to vibrate, so that the outlet valve constantly opens and closes, which impairs the operating performance of the high-pressure pump and puts a heavy load on the high-pressure pump because of pressure peaks that occur in the pump work chamber when the outlet valve is closed.

### ADVANTAGES OF THE INVENTION

The high-pressure pump of the invention having the characteristics of claim 1 has the advantage over the prior art that to keep the inlet valve and/or the outlet valve open, only a slight pressure difference upstream and downstream of the valve is necessary, since because of the shift of the smallest flow cross section away from the sealing face outward in the region of the sealing face, a higher static pressure results, by which a strong force acting on the valve member in the opening direction is generated. The pressure in the fuel inlet can be kept relatively slight as a result, which makes a correspondingly smaller feed pump possible, and because of the lesser pressure losses in the flow through the inlet valve, the filling of the pump work chamber is improved. In the case of the outlet valve, the shifting of the smallest flow cross section assures stable opening, so that the load on the high-pressure pump is reduced.

In the dependent claims, advantageous features and refinements of the high-pressure pump according to the invention are disclosed. By means of the embodiment defined by claim 2, the disposition of the smallest flow cross section downstream of the sealing face of the valve member is made possible in a simple way.

### DRAWING

One exemplary embodiment of the invention is shown in the drawing and described in further detail in the ensuing description.

FIG. 1 shows a high-pressure pump for a fuel injection system of an internal combustion engine;

FIG. 2 shows an inlet valve of the high-pressure pump enlarged and in longitudinal section;

FIG. 3 shows a modified version of the inlet valve; and

FIG. 4 shows an outlet valve of the high-pressure pump in a longitudinal section.

### DESCRIPTION OF THE EXEMPLARY EMBODIMENT

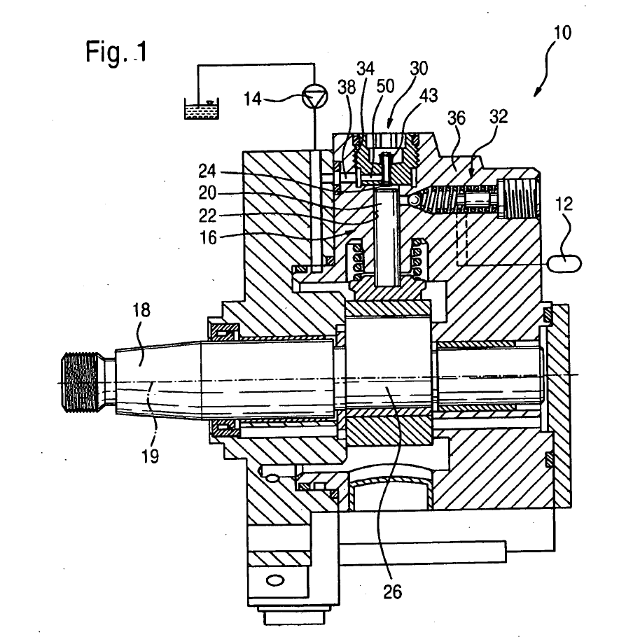

In FIG. 1, a high-pressure pump 10 is shown for a fuel injection system of an internal combustion engine, which is preferably a self-igniting internal combustion engine. By means of the high-pressure pump 10, fuel is pumped at high pressure into a reservoir 12, from which fuel is withdrawn for injection to the engine. The high-pressure pump 10 is supplied with fuel by the feed pump 14. The high-pressure pump 10 has at least one pump element 16, which has a pump piston 20 that is driven in a reciprocating motion at least indirectly by a drive shaft 18 of the high-pressure pump 10. The pump piston 20 is tightly guided in a cylindrical bore 22 extending at least approximately radially to the drive shaft 18, and it defines a pump work chamber 24 in the outer end region, remote from the drive shaft 18, of the cylindrical bore 22. The drive shaft 18 has a cam or a shaft portion 26 that is eccentric to its axis of rotation 19, by way of which cam or shaft portion the reciprocating motion of the pump piston 20 is brought about upon the rotary motion of the drive shaft 18. The pump work chamber 24 can be made to communicate with a fuel inlet of the feed pump 14, via an inlet valve 30 that opens into the pump work chamber 24 and is embodied as a check valve. The pump work chamber 24 can also be made to communicate with a fuel outlet to the reservoir 12, via an outlet valve 32 opening out of the pump work chamber 24 and embodied as a check valve. In the intake stroke, the pump piston 20 moves radially inward in the cylindrical bore 22, so that the volume of the pump work chamber 24 is increased. In the intake stroke of the pump piston 20, because of the pressure difference existing then, the inlet valve 30 is opened, since a higher pressure than the pressure prevailing in the pump work chamber 24 is generated by the feed pump 14, and thus fuel pumped by the feed pump 14 is aspirated into the pump work chamber 24. The outlet valve 32 is closed upon the intake stroke of the pump piston 20, since a higher pressure prevails in the reservoir 12 than in the pump work chamber 24.

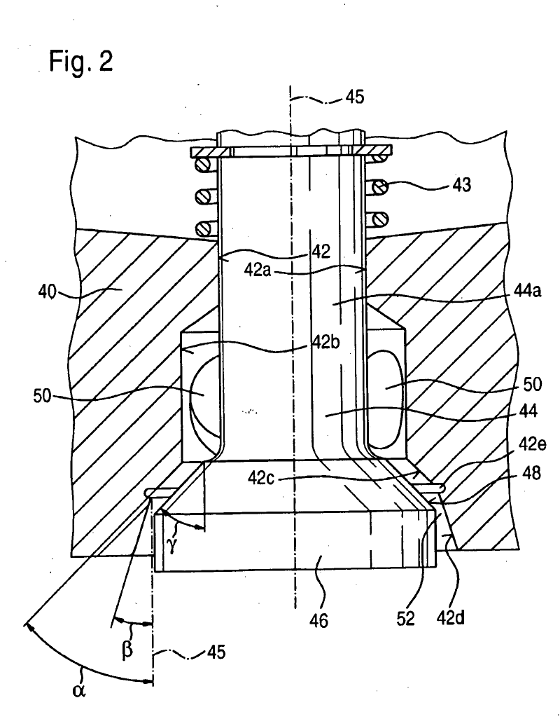

Below, the inlet valve 30 will be described in further detail as an example, in conjunction with FIG. 2. The inlet valve 30 is inserted for instance into a bore 34, adjoining the cylindrical bore 22 radially outward, of a housing part 36 of the high-pressure pump 10. The bore 34 is embodied with a larger diameter than the cylindrical bore 22. The housing part 36 may for instance be a cylinder head, which is connected to some other housing part in which the drive shaft 18 is supported, or a housing part in which the drive shaft 18 is also supported. Discharging into the bore 34, near its end region toward the cylindrical bore 22, for instance approximately radially to the axis of the bore 34, is a fuel inflow conduit 38, which communicates with the feed pump 14. The inlet valve 30 has a valve housing 40, in which there is a bore 42 with a multiply graduated diameter. The bore 42 has one portion 42a of small diameter, another portion 42b of larger diameter adjoining the portion 42a toward the pump work chamber 24, another portion 42c adjoining the portion 42b toward the pump work chamber 24, and a portion 42d adjoining the portion 42c toward the pump work chamber 24. The inlet valve 30 has a piston like valve member 44, which is guided displaceably with a cylindrical shaft 44a in the bore portion 42a. The valve member 44 furthermore has a head 46, adjoining the shaft 44a and having a larger diameter than the shaft 44a; at the transition from the head 46 to the shaft 44a, there is a sealing face 48 on the valve member 44. The sealing face 48 extends at an angle γ inclined to the longitudinal axis 45 of the valve member 44, in such a way that the sealing face 48 approaches the longitudinal axis 45 toward the shaft 44a. The sealing face 48 is preferably embodied at least approximately frustoconically. Adjoining the sealing face 48, the head 46 of the valve member 44 may be embodied at least approximately cylindrically. The head 46 of the valve member 44 points toward the pump work chamber 24. The shaft 44a of the valve member 44 protrudes, with its end remote from the head 46, out of the bore portion 42a and is engaged there by a prestressed closing spring 43.

At least one inflow conduit 50 is made in the valve housing 40 and discharges into the bore portion 42b. Preferably, a plurality of inflow conduits 50 are present, for instance three of them, distributed uniformly over the circumference of the valve housing 40. The bore portion 42c is embodied such that its diameter increases from the bore portion 42b toward the bore portion 42d. The jacket face of the bore portion 42c is preferably embodied frustoconically, but may also be shaped in any other arbitrary way, for instance being curved in concave or convex fashion. The jacket face of the bore portion 42c extends at an angle α to the longitudinal axis 45 of the valve member 44. The angle of inclination α of the jacket face of the bore portion 42c is preferably somewhat larger than the angle γ by which the sealing face 48 of the valve member 44 is inclined, but it may also be somewhat smaller than the angle γ. The bore portion 42c forms a valve seat, with which the sealing face 48 of the valve member 44 cooperates. In the closed state, the valve member 44 rests with its sealing face 48 on the bore portion 42c; because of the difference between the angle of inclinations α and γ, the contact of the sealing face 48 is effected at the edge of the bore portion 42c, toward the bore portion 42b.

The bore portion 42d is embodied such that its diameter increases from the bore portion 42c toward the pump work chamber 24. The jacket face of the bore portion 42d is preferably embodied frustoconically, but may also be shaped in any other arbitrary way, for instance being concave or convex. The jacket face of the bore portion 42d is inclined by an angle β to the longitudinal axis 45 of the valve member 44. The angle β by which the jacket face of the bore portion 42d is inclined to the longitudinal axis 45 is less than the angle α by which the jacket face of the bore portion 42c is inclined to the longitudinal axis 45. At the transition between the bore portions 42c and 42d, an undercut 42e is preferably provided, to enable simple production of the two bore portions 42c and 42d with the different angle of inclinations α and β. The undercut 42e preferably has a jacket face extending at least approximately parallel to the longitudinal axis 45. The outer diameter of the head 46 of the valve member 44 is somewhat smaller than the diameter of the undercut 42e, that with the edge at the transition from the head 46 to the sealing face 48, it can plunge into the undercut 42e somewhat in the closed state. By means of the undercut 42e, a collision between the head 46 of the valve member 44 and the valve housing 40 is thus avoided.

By means of the above-described embodiment of the valve housing 40 with the bore portions 42c and 42d, whose angle of inclinations α and β differ, it is attained that in the opened state, when the valve member 44 with its sealing face 48 has lifted from the bore portion 42c that forms the valve seat, the region 52 of the smallest flow cross section is present between the cylindrical portion of the head 46 of the valve member 44 and the bore portion 42d. In this region 52 of the least flow cross section, with the inlet valve 30 open, the highest flow velocity prevails and thus a low static pressure. The region 52 is thus located downstream, in the flow direction of the fuel from the inflow conduit 50 into the pump work chamber 24, of the sealing face 48 of the valve member 44. Thus in the region of the sealing face 48 of the valve member 44, there is a lesser flow velocity than in the region 52, and correspondingly a relatively high static pressure. This static pressure, acting on the sealing face 48 of the valve member 44, generates a force acting in the opening direction on the valve member 44 and thus reinforces the opening motion of the valve member 44 and the stable location of the valve member 44 in its opened state.

In the intake stroke of the pump piston 20, the inlet valve 30 opens, when the force generated in the opening direction on the valve member 44 by the pressure prevailing in the fuel inlet 38, which acts on the part of the sealing face 48 of the valve member 44 located inside the valve seat 42c, is greater than the sum of the force on the valve member 44 generated by the pressure prevailing in the pump work chamber 24 and the force generated by the closing spring 43. Once the valve member 44 has lifted with its sealing face 48 from the valve seat 42c, the entire sealing face 48 is subjected to pressure, and because of the location of the region 52 having the smallest flow cross section downstream of the sealing face 48 a relatively high static pressure acts on the sealing face 48 and keeps the valve member 44 in its opened state. In the pumping stroke of the pump piston 20, the pump piston generates an elevated pressure in the pump work chamber 24, by which pressure the inlet valve 30 is closed.

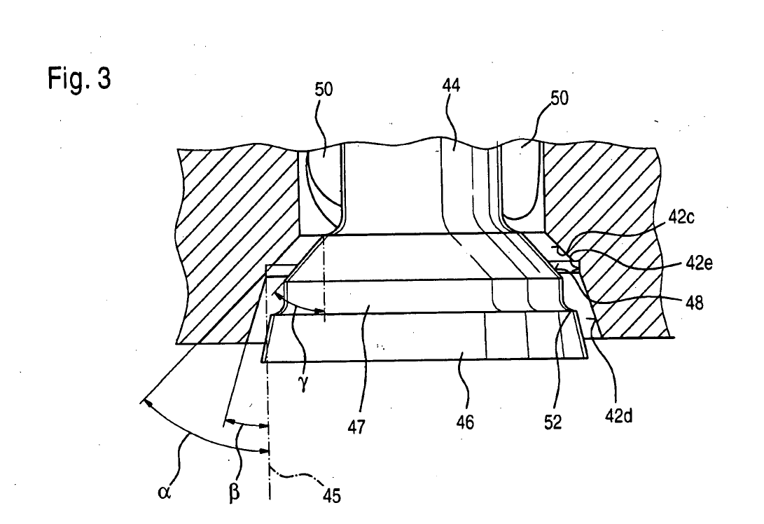

In FIG. 3, a modified version of the inlet valve 30 is shown, in which the basic structure is the same as in the version of FIG. 2, but the valve member 44 is modified. Here the head 46 of the valve member 44, toward its end toward the shaft 44a, has a region 47 of reduce diameter compared to the remaining diameter of the head 46. The region 47 of reduced diameter of the head 46 of the valve member 44 is disposed such that it is located facing the transition between the first jacket face 42c and the second jacket face 42d of the valve housing 40, when the valve member 44 is in its closing position. Because of the reduction in diameter in the region 47, a collision of the head 46 of the valve member 44 with the valve housing 40 is avoided. The reduction in diameter in the region 47 forms a step on the head 46 of the valve member 44, at its transition to the sealing face 48. The transition from the region 47 to the remainder of the head 46 of the valve member 44 having a large diameter may be rounded, as shown in FIG. 3. The head 46 of the valve member 44 may be embodied approximately cylindrically, as shown in FIG. 2, or approximately frustoconically, as shown in FIG. 3; the diameter of the head 46 in the latter case increases toward the pump work chamber 24, thereby improving the flow around the head 46 of the valve member 44.

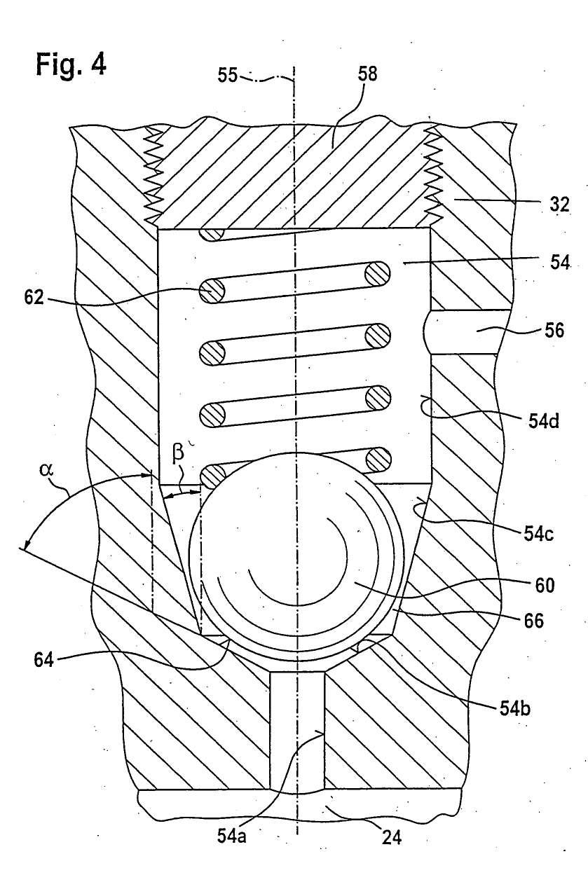

Below, as an example, the outlet valve 32 will be described in further detail in conjunction with FIG. 4. The outlet valve 32 is inserted for instance into a bore 54 in the housing part 36. A fuel outflow conduit 56, which communicates with the reservoir 12, discharges into the bore 54, for instance approximately radially to the longitudinal axis of the bore. The housing part 36 forms a valve housing for the outlet valve 32; alternatively, a separate valve housing, inserted into the housing part 36, may be provided for the outlet valve 32. The bore 54 in the housing part 36 is embodied as multiply graduated in diameter and has one portion 54a of small diameter that discharges into the pump work chamber 24. The bore portion 54a is adjoined away from the pump work chamber 24 by a further bore portion 54b, whose diameter increases away from the pump work chamber 24. The bore portion 54b is preferably embodied at least approximately frustoconically, but alternatively it may also have a concave or convex jacket face. The jacket face of the bore portion 54b is inclined by an angle α to the longitudinal axis 55 of the bore 54. The bore portion 54b is adjoined away from the pump work chamber 24 by a further bore portion 54c, whose diameter increases away from the pump work chamber 24. The bore portion 54c is preferably embodied at least approximately frustoconically, but may alternatively have a concave or convex jacket face. The jacket face of the bore portion 54c is inclined by an angle β to the longitudinal axis 55 of the bore 54, and the angle β is smaller than the angle α. The bore portion 54c may be adjoined by a further bore portion 54d of constant diameter, which extends as far as the outside of the housing part 36. A closure element 58 is inserted, for instance screwed, into the bore portion 54d from the outside of the housing part 36.

The outlet valve 32 has a valve member 60, which is embodied at least approximately spherically. A closing spring 62 may be provided, which is fastened between the valve member 60 and the closure element 58 and by which the valve member 60 is pressed toward the pump work chamber 24. The valve member 60, with a sealing face 64 that is formed by a part of its surface, cooperates with the bore portion 54b, which forms a valve seat for the valve member 60. When the pressure in the pump work chamber 24 is low, the valve member 60 is kept with its sealing face 64 in contact with the valve seat 54b by the closing spring 62. On the valve member 60 in the closed state, only a relatively small portion of the surface, corresponding approximately to the diameter of the bore portion 54a, is acted upon by the pressure prevailing in the pump work chamber 24. When the pressure in the pump work chamber 24 rises, the outlet valve 32 opens, since the force in the opening direction, generated by the pressure acting on the valve member 60, is greater than the force of the closing spring 62.

Upon opening of the outlet valve 32, a flow cross section is uncovered between the sealing face 64 of the valve member 60 and the valve seat 54b. Between the circumference of the valve member 60 and the bore portion 64, there is also a region 66 with an uncovered flow cross section; the flow cross section when the valve is open is smaller in the region 66 than the flow cross section uncovered between the sealing face 64 and the valve seat 54b. Throttling of the fuel flow as it flows through the opened outlet valve 32 is thus effected in the region 66 with the least flow cross section, and not in the region of the sealing face 64 of the valve member 60. Thus in the region of the sealing face 64 of the valve member 60, there is a lesser flow velocity than in the region 66 of the smallest flow cross section, and therefore a higher static pressure than in the region 66.

Upon opening of the outlet valve 32, when its valve member 60 lifts with its sealing face 64 from the valve seat 54b, the surface area of the valve member 60 subjected to pressure is increased, since it is then no longer only the surface located inside the valve seat 54b that is subjected to pressure, but instead the larger surface area with toward the region 66. A high pressure force in the opening direction therefore acts on the valve member 60 and keeps the valve member 60 stably in its opened state, even if a large quantity of fuel is flowing through the outlet valve 32 at a high flow velocity. As the stroke of the valve member 60 lengthens in the opening direction, both the uncovered flow cross section between its sealing face 64 and the valve seat 54b and the flow cross section uncovered in the region 66 become larger; the flow cross section uncovered in the region 66 is always smaller than the flow cross section uncovered between the sealing face 64 and the valve seat 54b. The angle α, by which the valve seat 54b is inclined relative to the longitudinal axis 55 of the bore 54, can be selected as large, so that the valve seat 54b is relatively flat and thus has high wear resistance.

In a high-pressure pump, it may be provided that only the inlet valve 30 is embodied as described above in conjunction with FIG. 2 or FIG. 3, while the outlet valve 32 is embodied as a simple ball valve or cone valve. Alternatively, it may be provided that in a high-pressure pump, only the outlet valve 32 is embodied as described above in conjunction with FIG. 4, while the inlet valve 30 may be embodied as a simple cone seat valve or ball valve. Alternatively, a valve described as an outlet valve in conjunction with FIG. 4, with a spherical valve member, may also be used as an inlet valve in a high-pressure pump. Correspondingly, a valve, described in conjunction with FIG. 2 or FIG. 3 as an inlet valve, with a valve member with a conical sealing face, may also be used an outlet valve in a high-pressure pump. Preferably both the inlet valve 30 and the outlet valve 32 in a high-pressure pump are embodied as described above in conjunction with FIGS. 2 or 3 and 4.

1-8. (canceled)

9. In a high-pressure pump for a fuel injection system of an internal combustion engine, having at least one pump element which has a pump piston driven in a reciprocating motion and defining a pump work chamber, into which work chamber fuel is aspirated from a fuel inlet via an inlet valve in the intake stroke of the pump piston and from which work chamber fuel is positively displaced via an outlet valve into a high-pressure region in the pumping stroke of the pump piston, and the inlet valve and/or the outlet valve having a valve member, which with a sealing face cooperates with a valve seat disposed in a valve housing, and by means of the valve member in the opened state, when the valve member with its sealing face has lifted from the valve seat opens a flow cross section between the valve member and the valve housing, the improvement wherein, in the opened state of the valve member, a region having the smallest flow cross section between the valve member and the valve housing is located downstream, in the flow direction of the fuel flowing through the valve, of the sealing face of the valve member.

10. The high-pressure pump as recited in claim 9, wherein the valve housing comprises a first jacket face, inclined relative to the longitudinal axis of the high-pressure pump and surrounding the valve member, which jacket face forms the valve seat, and a second jacket face, adjoining the first jacket face and inclined relative to its longitudinal axis and surrounding the valve member that the angle of inclination of the second jacket face relative to the longitudinal axis being less than the angle of inclination of the first jacket face, the region of the smallest flow cross section being located between the valve member and the second jacket face of the valve housing in the opened state of the valve member.

11. The high-pressure pump as recited in claim 10, wherein the first jacket face and/or the second jacket face of the valve housing is embodied at least approximately frustoconically.

12. The high-pressure pump as recited in claim 9, wherein the sealing face of the valve member is embodied at least approximately frustoconically and is inclined to the longitudinal axis of the first jacket face preferably by a different angle from the angle by which the first jacket face of the valve housing is inclined relative to its longitudinal axis.

13. The high-pressure pump as recited in claim 10, wherein the sealing face of the valve member is embodied at least approximately frustoconically and is inclined to the longitudinal axis of the first jacket face preferably by a different angle from the angle by which the first jacket face of the valve housing is inclined relative to its longitudinal axis.

14. The high-pressure pump as recited in claim 1 1, wherein the sealing face of the valve member is embodied at least approximately frustoconically and is inclined to the longitudinal axis of the first jacket face preferably by a different angle from the angle by which the first jacket face of the valve housing is inclined relative to its longitudinal axis.

15. The high-pressure pump as recited in claim 10, further comprising an undercut at the transition between the first jacket face and the second jacket face of the valve housing, the undercut having a jacket face extending at least approximately parallel to the longitudinal axis.

16. The high-pressure pump as recited in claim 1 1, further comprising an undercut at the transition between the first jacket face and the second jacket face of the valve housing, the undercut having a jacket face extending at least approximately parallel to the longitudinal axis.

17. The high-pressure pump as recited in claim 12, further comprising an undercut at the transition between the first jacket face and the second jacket face of the valve housing, the undercut having a jacket face extending at least approximately parallel to the longitudinal axis.

18. The high-pressure pump as recited in claim 12, wherein the valve member comprises a shaft and a head of enlarged cross section compared to the shaft, the sealing face being located on the valve member at the transition between the shaft and a head, and a region on the head of the valve member having a cross section that is reduced compared to the rest of the cross section of the head, which region faces the transition between the first jacket face and the second jacket face in the valve housing.

19. The high-pressure pump as recited in claim 13, wherein the valve member comprises a shaft and a head of enlarged cross section compared to the shaft, the sealing face being located on the valve member at the transition between the shaft and a head, and a region on the head of the valve member having a cross section that is reduced compared to the rest of the cross section of the head, which region faces the transition between the first jacket face and the second jacket face in the valve housing.

20. The high-pressure pump as recited in claim 14, wherein the valve member comprises a shaft and a head of enlarged cross section compared to the shaft, the sealing face being located on the valve member at the transition between the shaft and a head, and a region on the head of the valve member having a cross section that is reduced compared to the rest of the cross section of the head, which region faces the transition between the first jacket face and the second jacket face in the valve housing.

21. The high-pressure pump as recited in claim 15, wherein the valve member comprises a shaft and a head of enlarged cross section compared to the shaft, the sealing face being located on the valve member at the transition between the shaft and a head, and a region on the head of the valve member having a cross section that is reduced compared to the rest of the cross section of the head, which region faces the transition between the first jacket face and the second jacket face in the valve housing.

22. The high-pressure pump as recited in claim 9, wherein the valve member is embodied at least approximately spherically; and wherein the sealing face is formed by a region of the surface of the valve member.

23. The high-pressure pump as recited in claim 10, wherein the valve member is embodied at least approximately spherically; and wherein the sealing face is formed by a region of the surface of the valve member.

24. The high-pressure pump as recited in claim 11, wherein the valve member is embodied at least approximately spherically; and wherein the sealing face is formed by a region of the surface of the valve member.

25. The high-pressure pump as recited in claim 15, wherein the valve member is embodied at least approximately spherically; and wherein the sealing face is formed by a region of the surface of the valve member.

26. The high-pressure pump as recited in claim 9, wherein a higher static pressure prevails than in the region of the smallest flow cross section; in the opened state of the valve member in the region of its sealing face and wherein as a result of the pressure acting on the sealing face, a force in the opening direction on the valve member is generated.

27. The high-pressure pump as recited in claim 15, wherein a higher static pressure prevails than in the region of the smallest flow cross section; in the opened state of the valve member in the region of its sealing face and wherein as a result of the pressure acting on the sealing face, a force in the opening direction on the valve member is generated.
